(19) United States
(12) Patent Application Publication
(10) Pub. No.: US 2003/0007903 A1
(43) Pub. Date: Jan. 9, 2003

(54) Method and apparatus for improving the cold-starting performance of selective CO oxidation catalysts

(76) Inventors: Carlo Saling, Dettingen/Teck (DE); Matthias Wolfsteiner, Kirchheim/Teck (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/173,984

(22) Filed: Jun. 19, 2002

(30) Foreign Application Priority Data
Jun. 20, 2001 (DE) 101 29 658.4

(51) Int. Cl. B01D 53/62; B01J 38/00

(52) U.S. Cl. 422/178; 423/247; 502/38; 422/177

(57) ABSTRACT

To improve the cold-start performance of a selective CO oxidation catalyst in a gas-cleaning stage of a gas generation system for producing a hydrogen-containing reformate gas (in particular for a fuel cell system), after the gas generation system has been switched off, a flow of medium is guided over the selective CO oxidation catalyst in order to flush out constituents which delay starting.

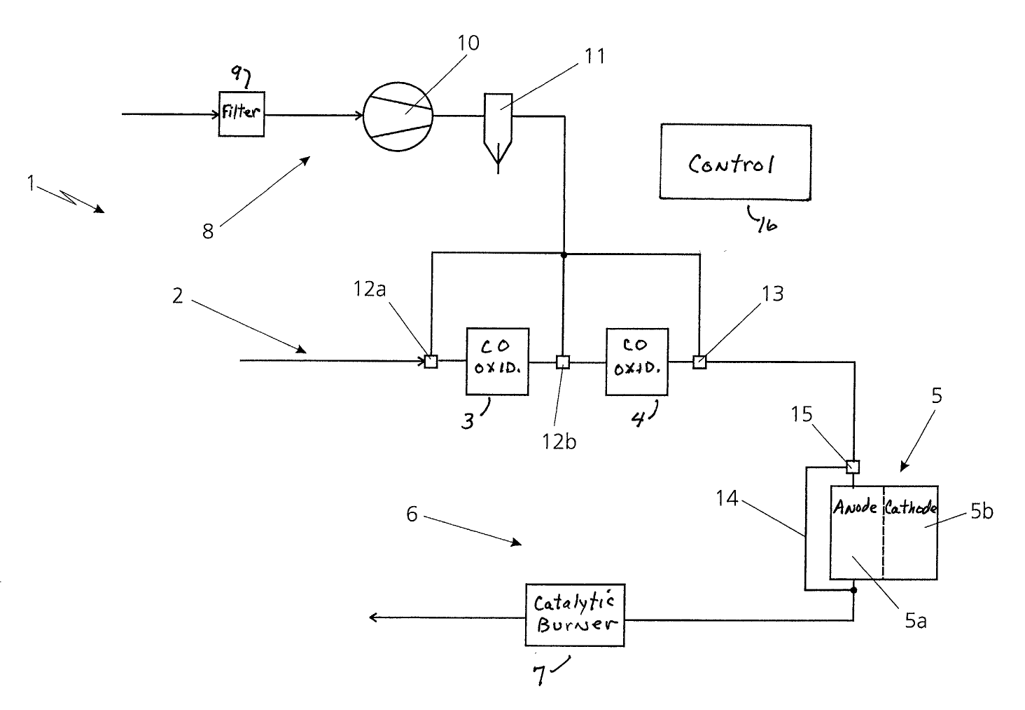

### BACKGROUND AND SUMMARY OF THE INVENTION

This application claims the priority of German patent document 101 29 658.4, filed Jun. 20, 2001, the disclosure of which is expressly incorporated by reference herein.

The invention relates to a method for improving the cold-starting performance of a selective CO oxidation catalyst for use in a gas cleaning stage of a gas generating system.

After a gas generation system has been operating (for example, in a motor vehicle with an integrated fuel cell system), water and fuel condense out of the reformate gas onto the surface of the CO oxidation catalyst as a result of the cooling of the reformate gas and the catalyst. Furthermore, after the gas generation system has been switched off, the selective CO oxidation catalyst is at least partially occupied by carbon monoxide (CO) as a result of what is known as chemisorption. Thus, pores and active centers on the surface of the selective CO oxidation catalyst (which is formed, for example, from a precious metal, such as platinum, ruthenium or palladium), are occupied. The result then is that, depending on the degree of coverage of the surface of the catalyst with these constituents, the temperature required to light or activate the catalyst increases, so that when the system is restarted well after it has been switched off (i.e., in this case in the event of a cold start), the time required to start the catalyst is lengthened. In very extreme cases, the light-off of the reaction on the catalyst may even be prevented altogether, particularly if, at very low temperatures, the catalyst and the moisture which condenses in it freeze.

Therefore, the object of the invention is to provide a method for reducing or avoiding altogether the occupation of the surface of a selective CO oxidation catalyst with constituents which delay the starting after the gas generation system has been switched off.

According to the invention, this object is achieved by flushing the catalyst with a flow of medium after the gas generation system has been switched off. In this manner, it becomes possible to remove or flush out the constituents which delay starting from the region of the selective CO oxidation catalyst. These constituents are primarily those which condense out of the reformate gas stream, in particular water and possibly residues of the starting material, such as for example methanol or the like. In addition, carbon monoxide (CO) which is chemisorbed in the region of the surface of the selective CO oxidation catalyst also plays a role in delaying the starting.

By flushing these substances out of the region of the catalyst in accordance with the invention, it is possible to ensure that a restart which takes place well after the system has been switched off (generally a cold start, in which temperatures in the region of the catalyst of from approx. −25° C. to +25° C. can be expected), can be decisively improved. In particular the time required until the catalyst is able to commence its intended disruption-free operation is shortened, such that the CO concentration in the reformate gas stream downstream of the catalyst can be reduced to a range which is harmless for further processing of the reformate gas stream, for example in a fuel cell. Particularly in the case of mobile applications, this provides a considerable benefit, since long heat-up times pose an unacceptable drawback to the operator of an installation of this type, for example in a motor vehicle.

In a particularly expedient embodiment of the invention, an oxygen-containing flow of medium, for example air, is used as the flow of medium, resulting in further advantages. That is, purging with an oxygen-containing flow of medium, such as for example air, not only ensures that the moisture and the chemisorbed constituents are flushed out of the region of the catalyst surface, but also causes the catalyst surface to be occupied by oxygen. Tests and measurements have shown that if a corresponding catalyst, (belonging, for example, to the platinum group) is correspondingly occupied by oxygen, an additional improvement in its cold-starting properties results.

Moreover, this configuration of the method according to the invention also makes it possible to achieve advantages in terms of the device technology, since oxygen-containing media are in any case delivered in the region of the selective active CO oxidation catalyst during standard, intended operation of a gas generation system. Thus, there is no need for additional compressors, line elements or the like in order to implement the method according to the invention.

Other objects, advantages and novel features of the present invention will become apparent from the following detailed description of the invention when considered in conjunction with the accompanying drawings.

### BRIEF DESCRIPTION OF THE DRAWINGS

The single appended figure shows part of a gas generation system 1 for fuel cell systems which are operated on the basis of liquid hydrocarbons as the energy store.

### DETAILED DESCRIPTION OF THE INVENTION

As depicted in the drawing, via a reformate section 2, a hydrogen-containing reformate gas passes from partial oxidation stages, reformers or the like (not shown) of the gas generation system 1, into the illustrated portion of the gas generation system 1. The reformate section 2 then leads, via two selective oxidation stages 3, 4, to a fuel cell 5 having anode and cathode chambers 5a, 5b, which are separated in a manner known per se by a proton-conducting membrane. An exhaust section 6 leads out of the gas generation system 1 from the fuel cell 5 via a catalytic burner 7. The exhaust section 6 may include further known means for cleaning and treating the exhaust gas, recovering pressure or the like; the latter are of no interest to the invention, however, and are therefore not shown.

The two preferably adiabatic selective oxidation stages 3, 4 are constructed in a manner which is known per se, and have a selectively active catalyst for oxidation of carbon monoxide (CO). The catalyst may be introduced into the selective oxidation stages 3, 4 in a known manner per se via beds, coatings or the like.

An air section 8 feeds ambient air into the region of the reformate section 2 via a filter 9 and a compressor 10. The air section 8 may also have a condensate or moisture separator 11, since an uncontrolled supply of moisture into the reformate gas stream of the reformate section 2 is often undesirable.

The connection between the air section 8 and the reformate section 2 is made via valve devices 12a, 12b, which may be, for example, valves or, as in the case illustrated here, Laval nozzles, and may be controlled, for example, by a (schematically depicted) control unit 16. Moreover, the air section 8 has a further connection to the reformate section 2, which is made via what is known as an air bled valve 13.

There are various possible options allowing the surfaces of the selective CO oxidation catalyst to be flushed appropriately in the region of the selective oxidation stages 3, 4 after the gas generation system has been switched off:

First, after the reformate section 2 has been switched to “pressure-free” operation, the pressure therein, together with residual levels of reformate gas, can be reduced via the exhaust section 6. Then, the two metering valves, which are designed, for example, as Laval nozzles 12a, 12b, can be opened, so that air is conveyed from the air section 8 into the reformate section 2, in particular into the region of the two selective oxidation stages 3, 4, via the compression device 10. The constituents which delay starting, and have been deposited in the region of the selective oxidation stages 3, 4 (i.e., in particular moisture and chemisorbed CO), are flushed out into the region of the exhaust section 6 via this air stream.

Secondly, the compression device in the air section 8 can be switched off together with the gas generation system. In this case, while the Laval nozzles 12a, 12b are still closed, the reformate section 2 is emptied in the manner described above. Between the compression device 10 and the Laval nozzles 12a, 12b the line elements contain air which is at a much higher pressure than the pressure prevailing in the reformate section 2 at this time. Opening the two Laval nozzles 12a, 12b causes this pressure to be released, with a flow of the air which has been temporarily stored in the region between compression device 10 and Laval nozzles 12a, 12b, the air flowing out through the two selective oxidation stages 3, 4 into the region of the exhaust section 6.

Both alternatives ensure, without changing the structure of the device (i.e., without using additional components, line elements or the like), that the two selective oxidation stages 3, 4 are purged with air, so that constituents which delay starting are flushed out of the selective oxidation stages 9, 4 as soon as the gas generation system 1 is switched off.

The required throughput of air and its enthalpy content are so low that it could be passed without problems through the anode chamber 5a of the fuel cell 5. However, frequently a bypass 14 is provided, with a corresponding valve device 15, for the purpose of emptying the reformate section 2, so that the purging of the selective oxidation stages 3, 4 can also be effected without problems via this bypass 14.

The air bleed valve 13 is of no further importance in connection with the present invention, and consequently it should merely be mentioned at this point that this valve should remain closed during the purging of the selective oxidation stages 3, 4, in order to prevent the substances which have been flushed out from flowing back into the air section 8.

The purging of the selective oxidation stages 3, 4 by means of the air delivered by the compression device 10 or air which has been temporarily stored in the air section 8 should take place at a temperature at which the constituents that are in vapor form in the selective oxidation stages 3, 4 (namely, water, fuel residues or the like), have not condensed out, so that they can very easily be flushed out in their gaseous or vapor phase. Therefore, it is recommended that the purging be carried out immediately after the gas generation system 1 has been switched off (i.e., before the selective oxidation stages 3, 4 have finally cooled).

In addition, purging with the oxygen-containing medium air leads to activation of the catalyst with oxygen, which can in turn improve the cold-start performance and shorten the cold-start time of the corresponding catalysts.

To ensure that no unnecessary moisture is introduced into the selective oxidation stages, 3, 4, the moisture separator 11 is important to the application proposed in the present invention. If this moisture separator is not already present, it will be the only component that may be required in addition to the existing structure of the gas generation system 1 in order for the method to be carried out.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for improving cold-start performance of a selective CO oxidation catalyst in a gas-cleaning stage of a gas generation system for the production of a hydrogen-containing reformate gas, said method comprising:
after the gas generation system has been switched off, flushing out constituents which delay the starting, by guiding a flow of a medium over the selective CO oxidation catalyst.

2. The method according to claim 1, wherein said medium comprises an oxygen-containing medium.

3. The method according to claim 1, wherein the flow of medium is guided over the selective CO oxidation catalyst before final cooling of the latter.

4. The method according to claim 1, wherein:
a reformate section, which includes the selective CO oxidation catalyst is first switched to pressure-free operation; and
in said flushing step, a pressurized quantity of medium that is stored between a compression device and valve devices is released into and flows through a region of the selective CO oxidation catalyst.

5. The method according to claim 1, wherein:
a reformate section, which includes the selective CO oxidation catalyst is first switched to pressure-free operation; and
in said flushing step, the flow of medium is conveyed from a compression device, via open valve devices over the selective CO oxidation catalyst.

6. The method according to claim 4, wherein devices which, in a standard operating mode of the gas generation system, are provided for feeding oxygen-containing medium to the selective CO oxidation catalyst are used as a compression device and valve devices.

7. The method according to claim 1, wherein after the flow of medium has been guided over the selective CO oxidation catalyst, it is passed via a bypass around an anode chamber of a fuel cell.

8. The method according to claim 1, wherein said gas generating system supplies said hydrogen-containing reformate gas to a fuel cell system.

9. The method according to claim 4, wherein said valve devices comprise one of valves and nozzles.

10. The method according to claim 5, wherein said valve devices comprise one of valves and nozzles.

11. Apparatus for improving cold starting performance of a selective CO oxidation catalyst in a gas cleaning stage of a gas generating system for production of a hydrogen-containing reformate gas, said apparatus comprising:
a source of a compressed gaseous medium; and
means of guiding a flow of said gaseous medium over the selective CO oxidation catalyst, flushing constituents that delay starting of the CO oxidation catalyst, after the gas generating system has been switched off.

12. The apparatus according to claim 11, wherein:
said source of compressed air comprises a compressor; and
said means for guiding a flow of said gaseous medium comprises valve devices.

13. The apparatus according to claim 12, wherein said source of compressed air further comprises a moisture separation device.

14. The apparatus according to claim 11, wherein said compressed gaseous medium comprises oxygen.
